(19) United States
(12) Patent Application Publication
(10) Pub. No.: US 2026/0202129 A1
(43) Pub. Date: Jul. 16, 2026

(54) CONTINUOUS FREEZE-DRYING SYSTEM WITH ROTATING HELICAL TUBE AND CONTINUOUS FREEZE-DRYING METHOD

(71) Applicant: Syntegon Telstar Technologies, S.L.U., Barcelona Terrassa (ES)

(72) Inventors: Maria Santafé Villarroya, Terrassa Barcelona (ES); Ignacio Cantera García, Terrassa Barcelona (ES)

(21) Appl. No.: 19/450,922

(22) Filed: Jan. 16, 2026

(30) Foreign Application Priority Data
Jan. 16, 2025 (EP) 25382021

(51) Int. Cl. F26B 5/06; F26B 5/04; F26B 17/18

(52) U.S. Cl. CPC F26B 5/06; F26B 5/041; F26B 17/18

(57) ABSTRACT

A freeze-drying system includes a drying device configured for receiving frozen particles of a substance and for drying the particles. The drying device includes a rotatable tubular member having an inlet section, an outlet section and an intermediate helical section. The freeze-drying system also includes a vacuum pump system for maintaining a vacuum inside the tubular member and a temperature regulation system configured for controlling a temperature in the tubular member. Furthermore, the system includes a drive for rotating the rotating tubular member and thereby convey the particles. A control system is also provided for controlling the drive and the temperature regulation system such that the received frozen particles have been dried when arriving at and end of the outlet section. The present disclosure also relates to a freeze-drying method for performing freeze-drying of a substance.

### BACKGROUND

The present disclosure relates to a freeze-drying system and, more particularly, to a freeze-drying system for continuous freeze-drying of a substance. The present disclosure also relates to a method for performing continuous freeze-drying.

Freeze-drying or lyophilization is a low-temperature and low-pressure dehydration process. It is utilized in many different fields to preserve or stabilize the properties of materials over long periods of time and under various conditions. Freeze-drying is particularly adequate for heat sensitive products, such as certain food products or, even more critically, for pharmaceutical or biological products, such as vaccines or microorganisms. Indeed, freeze-drying improves the stability of pharmaceutical products and, due to the limited temperatures employed during the process, can effectively preserve the functionality or activity of the active pharmaceutical ingredients.

A typical freeze-drying process comprises three basic steps. First, a freezing step is carried out on a liquid solution, so that the product is frozen. The liquid solution can comprise a solvent and a solute dissolved in the solvent. Alternatively, a dispersion medium with a dispersed dispersoid may be employed. Control of the freezing process is highly critical as the size and distribution of the ice crystals can significantly impact the efficiency of the next steps. Subsequently, a primary drying in a low-temperature and low-pressure environment is carried out. Hence, the pressure around the frozen material is lowered and heat is applied. In this manner, the substance is dried by removing ice by sublimation, thus giving place to a dry product. Finally, a secondary drying, which consists in removing the residual adsorbed water by desorption, is carried out. Secondary drying is also performed in a vacuum condition.

Freeze-drying systems and methods can be classified according to different criteria. A first distinction can be made between batch manufacturing and continuous manufacturing. Batch manufacturing is the most common approach. In batch manufacturing, the freeze-drying process takes place in a predefined sequence of discrete tasks, in which a batch of raw material is loaded in the system and discharged after a pre-set time. Such tasks can typically occur in different locations, which introduces significant delays in the cycle time as well as increases the number of intermediate manipulations. On the contrary, continuous processes are integrated and the different steps are carried out without interruptions and in a continuous sequence. Continuous manufacturing exhibits multiple advantages, such as increased flexibility, higher energy efficiency, increased productivity, or improved quality assurance.

Continuous manufacturing, due to its reduced number of manipulations and improved quality assurance, can be particularly advantageous for the lyophilization of products in the pharmaceutical or biological sectors.

Indeed, strict standards of current Good Manufacturing Practices (cGMP) are required for the manufacturing, processing, packaging, or holding of biological and pharmaceutical products. In this respect, there are several standards applicable to equipment in aseptic environments, see for example, EU GMP Part 1, annex1 and annex 15 or 21 CFR part 211 subpart D, in force in March 2024. There are also several design guidelines for equipment such as ASME BPE where comprehensive rules are summarized.

Freeze-drying systems can also be classified according to whether they operate with vials, i.e. with unit doses, or with bulk materials. Freeze-drying systems working with vials have exhibited some advantages for certain products, such as pharmaceutical products, due to, e.g. improved control on dosage. However, these systems must be designed for complex loading and unloading handling operations, which need to account for a very wide range of shapes and/or dimensions of the containers. Furthermore, the use of vials can result in uneven product properties with vial-to-vial inhomogeneity due to different individual conditions, e.g. different local temperatures, during the freezing or the drying processes.

Due to these challenges, freeze-drying systems operating with bulk material, either in solid or liquid form, are being increasingly proposed for continuous freeze-driers. Accordingly, some systems and methods for continuous freeze-drying of substances are already known. Nevertheless, such known solutions still exhibit some drawbacks or limitations. Consequently, and even if the benefits of continuous processing have been recognized, freeze-dried pharmaceutical products, e.g. drugs, are still being manufactured using the batch technology. The delay in the pharmaceutical industry, with respect to, e.g. food production, is due to the pharmaceutical regulatory requirements. Among others, these include much stricter requirements of sterility, product quality, and accurate dosage in the case of drugs. At present, continuous freeze driers do not allow good enough control of these parameters, therefore they have still not been considered suitable for large-scale industrial production in the pharmaceutical industry. Among others, physical damage of the resulting products or difficult adjustment of the freeze-drying process, have been identified as challenges for the proposed systems for continuous processing.

The present disclosure aims to reduce at least partially one or more of the aforementioned drawbacks so as to provide a freeze-drying system and method with improved control over the resulting products.

### SUMMARY

In an aspect of the present disclosure, a continuous freeze-drying system is provided. The system comprises a drying device configured for receiving frozen particles of a substance and for drying the particles. The drying device comprises a rotatable tubular member comprising an inlet section, an outlet section and an intermediate helical section. The freeze-drying system also comprises a vacuum pump system for maintaining a vacuum inside the tubular member and a temperature regulation system configured for controlling a desired temperature in the tubular member. Furthermore, the system comprises a drive for rotating the rotating tubular member and thereby convey the particles. A control system is also provided for controlling the drive and the temperature regulation system such that the received frozen particles have been dried when arriving at and end of the outlet section.

According to this aspect of the disclosure, a freeze-drying system with improved capabilities is provided. The substance may initially comprise a solution including a solvent, e.g. water, and a solute. The solution may be subsequentially frozen. The solute may comprise a pharmaceutical product, such as those used diagnostically or therapeutically.

The use of a tubular member, and more particularly, of a tubular member including an intermediate helical section, i.e. a helical tube, results in a smooth conveying of the frozen particles or granules. The tubular member provides a smooth surface that allows frozen particles to be dried in a uniform manner as they move forward. Specifically, frozen particles are in direct contact with the heating surface of the tubular member. This results in a more uniform heat transfer to the particles than in other existing systems such as those wherein particles are provided in vials or other types of containers.

The movement of the particles is induced by the rotation of the tubular member with the drive, which results in a gentle and smooth handling of the particles. Accordingly, particles are not subjected to vibrations or bouncing during the drying step. Such vibrations or bouncing movements can be found in some prior-art systems utilizing vibrating systems, e.g. vibratory conveyors, to enable uniform heating of the particles. Specifically, some prior-art systems comprise multiple trays or platforms inside the drying device. Such platforms are typically arranged at different heights, and they may be inclined to facilitate movement of the frozen particles during drying. Frozen particles jump or fall between trays, e.g. from upper platforms to lower platforms. Such jumps can induce mechanical damage on the particles during the drying process. On the contrary, in the system according to the present disclosure, the structural integrity of the particles is maintained, thus protecting and preserving the active properties of the substance. This aspect is especially relevant in the case of pharmaceutical or biological products. Besides, the formation of clusters of particles is minimized by providing a continuous rotational movement of the tubular member during the drying sequence. Furthermore, the rotational movement of the tubular member results in a superior heat transfer due to the continuous mixing of the granular frozen product, i.e. of the frozen particles. Such superior heat transfer can substantially reduce the drying time of the particles.

The freeze-drying system according to this aspect comprises a control system configured for controlling the drive and the temperature regulation system. The provision of such a control system increases the flexibility or versatility of the system. Indeed, different substances, particularly chemical or pharmaceutical substances, may require different drying conditions, e.g. temperature or time. Accordingly, the drying process can be controlled by optimizing a combination of temperature and conveying speed. Besides, pressure during drying may also be controlled with the control system.

The control system can be configured to adjust the rotational speed of the tubular member by controlling the drive and to adjust the temperature with the temperature regulation system. Those parameters can be tuned according to the requirements of the specific substance. Besides, such control can also increase the quality of the obtained products and, more specifically, the homogeneity and uniformity of the dried particles or granules. Hence, the parameters may also be adjusted during different freeze-drying sequences of a same substance while monitoring the properties of the obtained particles. In this manner, the different parameters can be adjusted to obtain particles with properties lying within certain predetermined quality ranges. Furthermore, in an example, the control system can also be configured to control the process pressure and, more particularly, the pressure in the volume of the tubular member.

The control system may also be adjusted based on the quantity of substance to be processed. Indeed, different processing times, temperatures and/or pressures may be needed for the effective drying of the particles depending on the mass and/or volume of the particles being processed per unit of time.

Further advantages arise from the use of a drying device comprising a substantially hollow or empty volume with a smooth internal surface. Hence, movement of the particles from a first end to an opposed end of the tubular member is induced by rotation of the tubular member itself. No mechanisms or complex devices, e.g. involving moving parts, are provided inside the evacuated, unobstructed, volume of the tubular member. The tubular member provides a substantially smooth surface with a very limited number of nooks or regions comprising narrow turns or bends.

At least two advantages arise from such unobstructed or open space within the tubular member. On the one hand, higher efficiency can be achieved due to an optimum usage of the processed substance, which can be smoothly conveyed along the tubular member, thus avoiding waste of material during the conveying process. On the other hand, cleaning of the drying device is also facilitated by such an unobstructed space. Accordingly, any remnants of particles of the processed substance can be effectively removed after use of the freeze-drying system for the lyophilization of a certain substance and before the use of the freeze-drying system for the processing of a different substance. Cleaning and sterilization can be carried out with clean-in-place (CIP) and/or steam-in-place (SIP) processes. Regarding SIP, a plurality of ports may be provided to insert steam at relatively high temperatures, e.g. in the range of 120° C. to 135° C. Consequently, proper sterility of the freeze-drying system and of the associated process is achieved. This aspect is especially relevant for the processing of pharmaceutical products because current Good Manufacturing Practices (cGMP) impose strict requirements to avoid any cross-contamination when using an apparatus to manufacture and/or process different substances.

In another aspect of the disclosure, a method for performing freezing-drying of a substance is provided. The method comprises providing frozen particles of a substance in a drying device. The drying device comprises a rotatable tubular member at a vacuum. The method also comprises transferring the frozen particles to an inlet section of the tubular member, the tubular member comprising also an outlet section and an intermediate helical section. The frozen particles are then conveyed along the tubular member from the inlet section to the outlet section while rotating the tubular member and controlling a desired temperature along the tubular member so as to continuously dry the particles while the particles are conveyed. The pressure of the process can also be controlled while the frozen particles are conveyed. The method also comprises collecting dried particles in a collection station.

According to this further aspect of the disclosure, an improved freeze-drying process is achieved. In particular, enhanced control of the drying sequence by sublimation is provided. The process, according to this further aspect, exhibits the advantages already described with reference to the corresponding freeze-drying system. Hence, an enhanced control of the properties of the dried particles or granules is obtained while providing a gentle treatment of the particles, thus preserving the relevant properties of the dried particles. Accordingly, the method according to the present disclosure is especially suited for the processing of biological or pharmaceutical products, for which cGMPs need to be observed. Thus, the drying of the particles during the sublimation process in the evacuated tubular member is carried out in a smooth, uniform, clean and repetitive manner.

Throughout this disclosure, an inlet section of the rotatable tubular member is understood as the section of the tubular member that receives the frozen particles, whereas an outlet section of the tubular member is understood as the section of the tubular member that discharges the dried granules. An intermediate helical section is understood as the section of the tubular member that lies between the inlet and the outlet section and which comprises a helical tube. Accordingly, the inlet section extends from the point where the frozen particles are received by the tubular member to the start of the helical section of the tube, whereas the outlet section extends from the end of the helical tube to the point where the dried particles are discharged from the rotatable tubular member. Nevertheless, in some examples, the intermediate helical section may substantially extend for the whole length of the tubular member, so that the inlet section and the outlet section may simply correspond to the ends of such helical section.

Throughout this disclosure, the terms dry particles, granules or powder may be used interchangeably.

### BRIEF DESCRIPTION OF THE DRAWINGS

Non-limiting examples of the present disclosure will be described in the following, with reference to the appended drawings, in which:

FIG. 1 schematically illustrates an example of a drying device for use in a freeze-drying system;

FIG. 2 schematically illustrates a distribution of temperature stages in a drying device according to an example;

FIG. 3 schematically illustrates an example of a drive for rotating a tubular member of a drying device;

FIG. 4 schematically illustrates an example of a helical tubular member with characteristic parameters;

FIGS. 5A and 5B schematically illustrate two examples of a vacuum freezing device for use in a freeze-drying system;

FIG. 6 schematically illustrate a continuous freeze-drying system comprising a vacuum freezing device connected to a drying device according to an example;

FIG. 7 shows a flowchart of an example of a freeze-drying method; and

FIG. 8 shows a flowchart of another example of a freeze-drying method.

### DETAILED DESCRIPTION

Reference now will be made in detail to embodiments of the disclosure, one or more examples of which are illustrated in the drawings. Each example is provided by way of explanation of the disclosure, not as a limitation. In fact, it will be apparent to those skilled in the art that various modifications and variations can be made in the present disclosure without departing from the scope or spirit of the teaching. For instance, features illustrated or described as part of one embodiment can be used with another embodiment to yield a still further embodiment. Thus, it is intended that the present disclosure covers such modifications and variations as come within the scope of the appended claims and their equivalents.

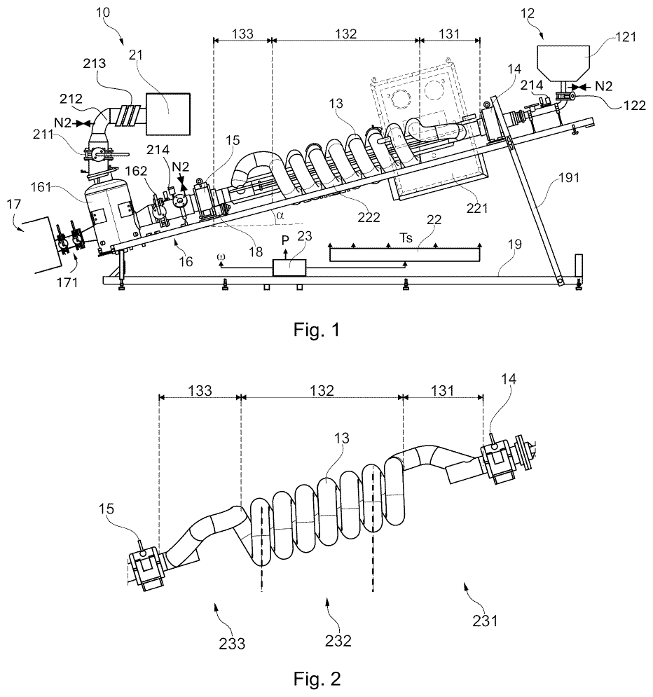

FIG. 1 shows an example of a drying device 10 for use in a freeze-drying system and, more particularly, in a continuous freeze-drying system.

The system comprises a drying device 10 configured for receiving frozen particles of a substance, for drying the particles, and for collecting the dried particles. The drying device 10 comprises a rotatable tubular member 13 comprising an inlet section 131, an outlet section 133 and an intermediate helical section 132. The freeze-drying system also comprises a vacuum pump system 21 for maintaining a vacuum inside the tubular member 13 and a temperature regulation system 22 configured for controlling a desired temperature in the tubular member 13. Furthermore, the system comprises a drive 18 for rotating the rotating tubular member 13 and thereby convey the particles. A control system 23 is also provided for controlling the drive 18 and the temperature regulation system 22 such that the received frozen particles have been dried when arriving at and end of the outlet section 133. In an example, the control system 23 is also configured for controlling a pressure inside the system.

In an example of the disclosure, a station may be provided in the drying device 10 to receive the frozen particles or granules. Thus, as also schematically depicted in FIG. 1, the inlet section 131 of the tubular member 13 may be connected to a receiving station 12. As mentioned, the receiving station 12 may be configured for receiving the frozen particles. A connection between the inlet section 131 of the tubular member 13 and the receiving station 12 may comprise a rotating joint 14.

In this example, the receiving station 12 may comprise a container 121 and the frozen particles may be continuously supplied to the container 121. In order to provide a smooth and clean transfer between the receiving station 12 and the rotatable tubular member 13, a rotating joint 14 may be provided between an end part of the receiving station 12 and the inlet section 131 of the tubular member 13. A valve 122 may be provided in the receiving station 12. The valve 122 may be configured to control a flow of frozen particles from the container 121 of the receiving station 12 to the tubular member 13. In an example, the valve 122 may be automated and a flow of frozen particles may be dynamically controlled to adjust the speed and conditions of the drying process.

Furthermore, a temperature in the receiving station 12 may also be controlled to prevent melting or deterioration of the frozen particles. Accordingly, the temperature regulation system 22 may be configured to control a desired temperature in such receiving station 12.

In order to collect the dried material after the lyophilization process, in an example of the disclosure, the outlet section 133 of the tubular member 13 may be connected to a separation station 16, which may be connected to a collection station 17. The separation station 16 may be configured for separating the dried particles. The separation station 16 may use cyclonic separation and it may include a cyclone to separate dried particles from remaining vapor. Besides, similarly to the receiving station 12, a connection between the outlet section 133 of the tubular member 13 and the separation station 16 may comprise a rotating joint 15 as shown in FIG. 1.

The separation station 16 may comprise a container 161 to receive the dried particles (which may also be referred to as granules, powder or granular powder). As mentioned above, a cyclone, filter, or equivalent system, may be arranged inside the container 161 to facilitate separation of the dried particles from vapor. A rotating joint 15 may be provided to ensure a smooth and clean transition between the rotating tubular member 13 and the static container 161. Furthermore, a valve 162 may be provided in the separation station 16. In this manner, the dried powder may be collected from the container 161 while isolating the interior of the tubular member 13. In some examples, the valve 162 may be automated, i.e. it may be configured to operate in an automated manner. Similarly, an automated system may be provided to collect the dried particles or granules from the container 161 and to transfer them to the collection station 17 so as to proceed to a next processing step, e.g. dosing of dried product in a vial.

A valve system 171, e.g. a load lock system, may be arranged between the separation station 16 and the collection station 17. By controlling the valve system 171, the dried particles may be continuously transferred from the container 161 of the separation station 16 to the collection station 17 in a controlled manner. The collection station 17 may also be known as a dosage station and it may be arranged to distribute received dried particles into desired doses.

As seen in FIG. 1, the vacuum pump system 21 may be configured to maintain a certain vacuum level in the inner volumes of the drying device 10. In particular, the vacuum pump system 21 may be configured to maintain a vacuum, not only in the tubular member 13, but also in the receiving station 12 and the separation station 16. Actually, the inner volumes of such elements may constitute a single volume during operation as the respective valves 122, 162 may remain open.

In order to control the vacuum level, i.e. the pressure, in the inner volume of the drying device 10, the vacuum pump system 21 may comprise a number of vacuum pumps configured to reach a certain limit or base vacuum. One or more microvalves may be provided to introduce a controlled amount of an inert gas, e.g. nitrogen, N₂, into the volume. In other words, the microvalves may be used as a controlled leakage system to introduce a controlled flow of nitrogen so that the desired pressure is maintained. As shown in FIG. 1, these microvalves may be arranged at different locations. In particular, in the example shown in FIG. 1, a first microvalve may be arranged in the receiving section 12, more particularly, after the container 121 and before the tubular member 13. Another intermediate microvalve may be arranged downstream of the rotating joint 15. A third microvalve may be arranged in the evacuation line 212. Of course, it is understood that other locations and/or additional microvalves may be provided. The control system 23 may be configured to control the microvalves based on pressure readings provided by pressure sensors 214. More than one pressure sensors 214 may be provided but only one of them may be used by the control system 23 at a specific time to control the pressure.

The drying device 10 exhibits different advantages as described above. In particular, the drying device 10 allows a proper control of the drying process while the frozen particles are dried by sublimation in the tubular member 13, i.e. the frozen particles are dried by converting the solvent ice into vapor, without passing through the liquid phase. The vapor generated at the tubular member 13 is evacuated through an evacuation line 212 and a vacuum level during the drying process is maintained by the vacuum pump system 21 and the controlled leakage system comprising one or more microvalves as described above. In particular, an ambient pressure inside the drying device 10 and, more particularly, inside the tubular member 13, is lower than the solvent partial vapor pressure at the corresponding temperature.

Furthermore, in an example, a vapor condenser 213 may be arranged before the vacuum pump system 21 to condense and remove the vapor from the system. In particular, the condenser 213 may be configured to capture the sublimated water vapor so as to help maintain the vacuum level and prevent rehydration of the product.

A valve 211 may be provided to control a connection of the drying volume, e.g. the inner volume of the tubular member 13 (as well as the inner volumes of the receiving station 12 and separation station 16), with the vacuum pump system 21. As shown in the example of FIG. 1, the evacuation line 212 may be provided downstream of a container 161 arranged in a separation station 16. The valve 211 may be provided between such container 161 and the vacuum pump system 21. A further valve 162 may be provided between the tubular member 13 and the container 161. Accordingly, during drying of the frozen particles, both valves 211, 162 may be opened to connect the tubular member 13 with the vacuum pump system 21.

In an example, the vacuum pump system 21 may comprise one or more primary vacuum pumps and one or more Roots pumps. In an example, two or more evacuation lines 212, each of them connected to a respective condenser 213, may be provided. Accordingly, a first evacuation line 212 may be used until the respective condenser 213 becomes saturated. A defrosting step may then be carried out for the condenser 213 of the first evacuation line 212. Then, in order to continue with the process in a continuous manner, a second evacuation line 212, with its corresponding condenser 213, may be employed.

The intermediate helical section 132 provides an increased control over the conditions for particle drying. In particular, an improved control over the temperature and cycle time of the drying process is achieved.

In an example, the drive 18 may be configured to adjust a rotational speed of the tubular member 13 between 0.05 rpm and 10.00 rpm. Accordingly, different rotational speeds may be selected depending on, e.g. the substance to be dried, the size of the frozen particles, and/or the quantity or flow of particles being processed. In particular, the rotational speed may be adjusted over a relatively broad range so as to cover a variety of scenarios. In a variant of this example, the rotational speed may be pre-adjusted and maintained substantially constant during a drying cycle. In another variant, the control system 23 may be used to control the drive 18 during a drying cycle, so as to modify the rotational speed of the tubular member 13 during such drying cycle.

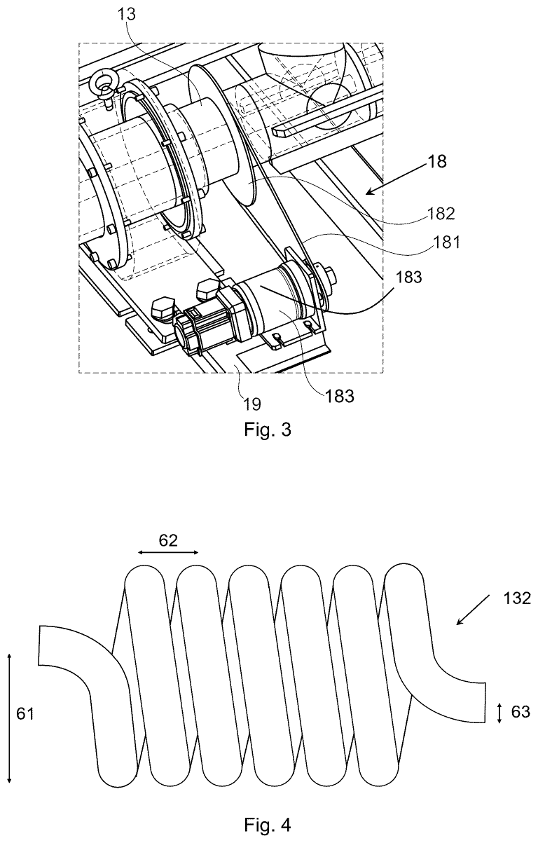

Different configurations may be provided for the drive 18 in different examples of the disclosure. As an example, FIG. 3 schematically depicts a configuration in which a servomotor 183 is used to rotate the tubular member 13. The speed and position of the tubular member 13 may be accurately adjusted by means of the driver of the servomotor 183 after taking into account commands provided by a control system 23. As shown in FIG. 3, the servomotor 183 may be mounted on the frame 19 and it may be coupled to a wheel 182 with a belt 181. The wheel 182 may be rigidly attached to or integrally formed with the tubular member 13. As also shown in FIG. 1, the drive 18 may be located at an outlet section 133 of the tubular member 13. In this example, a drive 18 comprising a single servomotor 183 is provided. Nevertheless, other examples may comprise a drive 18 with a plurality of servomotors, which may be arranged at different positions along the tubular member 13.

In an example, the rotatable tubular member 13 may be inclined with respect to a horizontal direction, such that the inlet section 131 may be at a higher vertical position than the outlet section 132. The inclination of the tubular member 13 may facilitate progression or movement of the particles along the tubular member 13 by the action of gravity. The inclination may be selected such that a certain average translational speed may be obtained for the particles while they undergo the drying process. The provision of such an inclination may be particularly useful in systems comprising tubular members 13 in which the intermediate helical section 132 does not extend for the whole length of the tubular member 13. Hence, in those cases, substantially straight sections may exist at the inlet section 131 and/or at the outlet section 133 of the tubular member 13. Movement of the particles along such substantially straight sections may be facilitated by such an inclination.

Moreover, inclination of the tubular member 13 may be particularly advantageous to facilitate draining when using clean-in-place (CIP) processes for cleaning and sterilization.

The inclination of the tubular member 13 is schematically represented in FIG. 1, where it is labelled as a. A frame 19 may be provided to accommodate the different parts of the drying device 10, such that an inclination, a, may be provided to the system. Progression or movement of the particles along the tubular member 13, in particular along the inlet section 131 and outlet section 133, is facilitated by the action of gravity. The inclination, a, may be selected such that a certain average translational speed may be obtained for the particles of the substance while they undergo the drying process. Similarly to the rotational speed, the inclination may also be selected depending on the specific needs of the processed substance. Thus, the dynamics of the drying process may be optimized by a combination of temperature, pressure and conveying speed. The conveying speed may be controlled by adjusting the rotational speed of the tubular member 13 and by selecting an appropriate inclination, a.

Furthermore, in some examples, the tubular member may be tiltable and a tilting device may be provided. The tilting device may be configured to adjust an inclination of the tubular member 13. Specifically, the inclination between the tubular member 13 and the horizontal direction may be between 0° and 45°, specifically between 5° and 40°.

According to a variant, the tilting device may comprise at least one adjustable beam 191 of the frame 19, whose position relative to other parts of the frame 19 may be adjustable. The adjustable beam 191 may be arranged at one end of the frame 19 structure corresponding to a high end position of the tubular member 13 whereas a hinge or pivot point may be provided at a low end of the tubular member 13. Specifically, the inclination, a, may be adjusted over a relatively broad range to increase the flexibility and versatility of the freeze-drying system by adjusting the slope of the tubular member 13.

In an example, the tilting device, e.g. the adjustable beam 191, may be controlled in real-time, i.e. during the drying process. In this manner, increased controllability may be provided so as to ensure a uniform drying of the frozen particles over time.

According to an example of the present disclosure, a plurality of temperature stages 231-233 may be defined along the tubular member 13 as schematically depicted in FIG. 2. The temperature regulation system 22 may be configured to individually control a temperature of the temperature stages 231-233. Furthermore, in an example, a controlled temperature stage may also be provided in the receiving station 12. The temperature stage in the receiving station 12 may be configured to prevent damage or melting of the frozen particles. Specifically, a temperature in the range of −45° C. to 0° C., more specifically in the range of −30° C. to −10 ° C., may be provided in the receiving station 12. Accordingly, the temperature regulation system 22 may be configured to control also the temperature in the temperature stage defined in the receiving station 12.

The definition of multiple temperature stages may provide increased control over the drying process. Furthermore, the number of temperature stages and the temperature at each of the temperature stages may be controlled by means of the temperature regulation system 22 so that different temperatures may be defined based on the physical properties of the processed substance, particle size, and/or processing quantity or flow. The definition of a plurality of temperature stages may facilitate a continuous and gradual provision of heat to facilitate sublimation and drying of the frozen particles entering the inlet section 131 while they are sequentially transferred to locations corresponding to the different temperature stages and, finally, discharged at the end of the outlet section 133.

The temperature regulation system 22 is schematically represented in FIG. 1 as a unique block but it is understood that the temperature regulation system 22 may actually comprise a plurality of components, which may be arranged at different locations. Hence, the temperature regulation system may comprise coolers (e.g. mechanical refrigeration systems) and/or heaters (e.g. heating wires or heating blankets) to define the temperature at different locations. Furthermore, different elements, such as physical enclosures or housings, may be arranged around specific portions of the tubular member 13 to define the temperature stages. Such enclosures or housings may improve the uniformity of the temperature in the respective temperature stage.

Furthermore, and as already mentioned, a receiving station 12 of the drying device 10 may also comprise a temperature stage. Accordingly, one or more components of the temperature regulation system 22 may also be provided at the location of such receiving station 12. The components may include mechanical refrigeration systems such as air conditioning systems or a coil arranged around the area and working as an evaporator with a refrigerant fluid expanding as it passes through it. Besides, physical enclosures or housings may also be arranged around the receiving station 12 (or parts of it) to facilitate uniformity of the corresponding temperature.

In the example shown in FIG. 1, a component of the temperature regulation system 22 may comprise one or more heating wires or blankets 222, which may be wound around an outer surface of the tubular member 13 and, more particularly, around the intermediate helical section 132 and the outlet section 133 of the tubular member 13. Furthermore, in order to improve the uniformity of the temperature on the heated sections of the tubular member 13, a thermal insulating cover or jacket may be arranged on the external surface of the tubular member 13. Uniformity and selection of the desired temperature may also be facilitated by proper control strategies in the control system 23 controlling the temperature regulation system 22. In another example, a system blowing hot air may be arranged to provide hot air in the surrounding environment of a certain section of the tubular member 13. In this case, an enclosure or housing may be provided to contain the hot air in a certain volume around a desired section of the tubular member 13 so as to achieve a uniform temperature in the respective temperature stage.

Moreover, in other examples, coolers may also be provided to obtain low temperatures, i.e. temperatures below room temperature. This may be particularly the case for temperature stages arranged around the inlet section 131 of the tubular member 13. Cooling may be provided by arranging thermoelectric devices, e.g. Peltier devices, which may be attached on an outer surface of the tubular member 13. Furthermore, a chiller, freezer or similar device may also be provided to cool air in a controlled volume surrounding a desired section of the tubular member 13. In an example, an air conditioning system may be provided to cool air, and a forced convection system comprising, e.g. fans, may be arranged to cool a certain portion of the tubular member 13. Thus, in an example like the one depicted in FIGS. 1 and 2, a cooling system may be arranged in an area overlapping at least a portion of the inlet section 131 and at least a portion of the intermediate helical section 132 so as to define a first temperature stage 231. In order to ensure a proper and uniform cooling, an enclosure or housing 221 may be arranged to contain the air in a controlled volume as also depicted in FIG. 1. Such cooling systems may also be arranged in the receiving station 12, in which especially low temperatures may be required to prevent any melting or deterioration of the frozen particles.

Temperature stages in certain sections of the tubular member 13, particularly in an intermediate helical section 132 or in an outlet section 133, may be kept at ambient temperature, i.e. at a temperature substantially corresponding to the room temperature of the processing plant where the freeze-drying system is arranged. In such case, the temperature regulation system 22 may also comprise the HVAC system employed for air conditioning of the facility. In other examples, the intermediate helical section 132 and the outlet section 133 may be kept at low temperatures with a cooling system.

In an example, the plurality of temperature stages may comprise at least three temperature stages: a first temperature stage including the inlet section 131, a second temperature stage including at least a portion of the intermediate helical section 132, and a third temperature stage including the outlet section 133. Besides, the temperature regulation system 22 may be configured to adjust the temperature such that the temperature is increased from the inlet section 131 to the outlet section 133. Moreover, as already indicated, a further temperature stage may be provided in the receiving station 12. The temperature at the receiving station 12 may be kept sufficiently low so as to prevent melting or damage on the frozen particles. In particular, the temperature in the receiving station 12 may be lower than the temperate at the inlet section 131 of the tubular member 13. Accordingly, in this variant, the temperature regulation system 22 may be configured to adjust the temperature such that it increases from the receiving station 12 to the outlet section 133 of the tubular member 13.

In an example, the temperature stages in the tubular member may substantially coincide with the different sections of the tubular member 13. Nevertheless, other examples may comprise different distributions of the temperature stages. In particular, more than one temperature stage may be arranged within the intermediate helical section 132. In other examples, the temperature of at least a portion of the intermediate helical section 132 may be substantially equal to the temperature of at least a portion of the inlet section 131 or the outlet section 133, thus giving place to a temperature stage overlapping two of the sections 131-133 of the tubular member 13.

In a variant of this example, which is schematically depicted in FIG. 2, a first temperature stage 231 may be provided covering the inlet section 131 and a first portion of the intermediate helical section 132. A second thermal section 232 may be provided around a center portion of the intermediate helical section 132. Finally, a third thermal section 233 may be provided extending over a last portion of the intermediate helical section 132 and the outlet section 133. In this manner, a gradual temperature increase may be provided within the intermediate helical section 132, which may provide enhanced control over the drying process. The distribution of the temperature stages may be dependent on the specific needs of the process, i.e. the physical characteristics of the substance and/or the processed quantity.

More particularly, the temperature in the first temperature stage of the tubular member 13 may be in the range −20° C. to 25° C., specifically between −10° C. and 20° C. The temperature in the second temperature stage may be in the range −20° C. to 60° C., more specifically in the range 25° C. to 60° C. The temperature in the third temperature stage may be in the range 0° C. to 60° C., specifically in the range 25° C. to 60° C. Furthermore, a further temperature stage may be provided in the receiving station 12 and the temperature in such stage may be in the range of −45° C. to 0° C., more specifically in the range of −30° C. to −10 ° C.

The temperature at each of the temperature stages may be varied over a wide range, thus providing increased flexibility to the system. The different temperatures may be selected so as to ensure a smooth and continuous sublimation of the frozen particles during the drying phase.

In still other examples, and as already described above, the intermediate helical section 132 may substantially extend over the whole length of the tubular member 13. Accordingly, different temperature stages may be defined within the intermediate helical section 132, whereas the inlet section 131 and the outlet section 133 may simply correspond to the ends of the intermediate helical section 132.

In order to control the temperature, the temperature regulation system 22, i.e. the heater and/or coolers of the temperature regulation system 22, may be controlled with a control system 23 as also depicted in FIG. 1. The control system 23 is depicted in FIG. 1 as a unique module providing control signals for the rotational speed, w, of the motor 18 and for the temperature regulation system 22. Nevertheless, although a single module is presented in FIG. 1, it is understood that this is just a schematic representation. In particular, in some examples, the control system 23 may comprise a distributed control system, i.e. a control system with multiple separate parts. Alternatively, a centralized control unit may also be provided in other examples of the disclosure.

Apart from the temperature and the rotational speed, the pressure inside the tubular member may also be controlled by control system 23. Hence, in examples of the disclosure, a micrometric valve may be provided to control a flow of an inert gas, e.g. nitrogen, which may be introduced inside the volume of the drying device 10 to adjust a pressure value. In particular, the pressure at a certain control location in the drying device 10 may be adjusted from 0,001 mbar to 2 mbar. Hence, a precise control of the pressure in the drying device 10 may be obtained by taking a preferred location as a reference point. Thus, in a variant of the disclosure, a pressure may be controlled at an inlet of the intermediate helical section 132 or at an outlet of the intermediate helical section 132. Alternatively, the pressure may also be controlled by taking the reference point in other locations along the tubular member 13, such as in the substantially straight inlet 131 or outlet sections 133, or in other points of the drying device 10 such as in the receiving station 12, in the separation station 16 or in the evacuation line 212.

A precise control of the pressure may be ensured by the present example. In order to convert the ice in the frozen particles into vapor, without passing through the liquid phase, the ambient pressure must be lower than the solvent partial pressure at the corresponding temperature.

The specific geometry of the tubular member 13 and, more particularly, of the intermediate helical section 132 comprising a helical shape, may significantly influence the efficiency of the freeze-drying process and the quality of the resulting dried particles. In an example of the disclosure, the tubular member 13 may have a radius 63 in a range from 5 to 35 cm and the intermediate helical section 132 may extend for at least 50% of a length of a center axis of the tubular member 13. The radius of the tubular member 13 may be substantially constant.

The length of a center axis of the tubular member 13 refers to the total distance, in a straight line, from the start point of the inlet section 131 to the end point of the outlet section 133, wherein the start and end point are referred to the flow direction of the particles. The combination of substantially straight sections and a helical section may be beneficial to optimize the process. In particular, a helical shape may allow for a shortening of the overall dimensions of the freeze-drying system and, more particularly, of the drying device 10.

In an example, the intermediate helical section 132 may extend for substantially 100% of the length of the tubular member 13. Accordingly, the inlet section 131 and the outlet section 133 may not exhibit any associated length and they may simply correspond to the first and second end of the intermediate helical section 132 wherein frozen particles are received (inlet section 131) or discharged (outlet section 133). In still other examples, the intermediate helical section 132 may reach only one of the ends of the tubular member 13 at one of the two sides, i.e. either the inlet section 131 or the outlet section 133 may substantially comprise an end of the intermediate helical section 132 with no associated length.

Moreover, not only the dimensions of the tube itself, but also the characteristics of the helix may significantly influence the process. Therefore, the parameters of the intermediate helical section 132 may be selected to optimize the drying process. FIG. 4 schematically illustrates the characteristic parameters of such a helical arrangement. In an example, the intermediate helical section 132 may comprise at least two turns. Besides, the helical radius 61 may be between 25 and 100 cm and the helical pitch 62 may be between 10 and 100 cm.

Such parameters may be selected to achieve a proper drying process while fulfilling overall mechanical and structural requirement for the tube.

FIG. 1 includes a receiving station 12, which is used to receive the frozen particles. Different methods and systems may be employed to obtain such frozen particles. In some examples, the frozen particles may be obtained by first freezing the substance as a thin sheet. The thin sheet may then be broken into pieces of a suitable dimension. In other examples, the substance may be simply frozen into large chunks, which may then be broken and comminuted into particles of desired dimensions. In still other examples, raw material can be frozen as it travels along an elongated conveyor which is surrounded by cooling coils. At the end of the conveyor, a crushing area can be arranged to crush and triturate the particles.

Unfortunately, processes involving breaking or crushing of frozen sheets and/or chunks can result in significant structural damage. Accordingly, the obtained frozen particles may be such that the properties of the substance, especially if biological or pharmaceutical products are considered, may be degraded. Accordingly, a process comprising a gentler treatment of the material and an improved control is preferred in cases comprising freeze-drying of products requiring scrupulous processing.

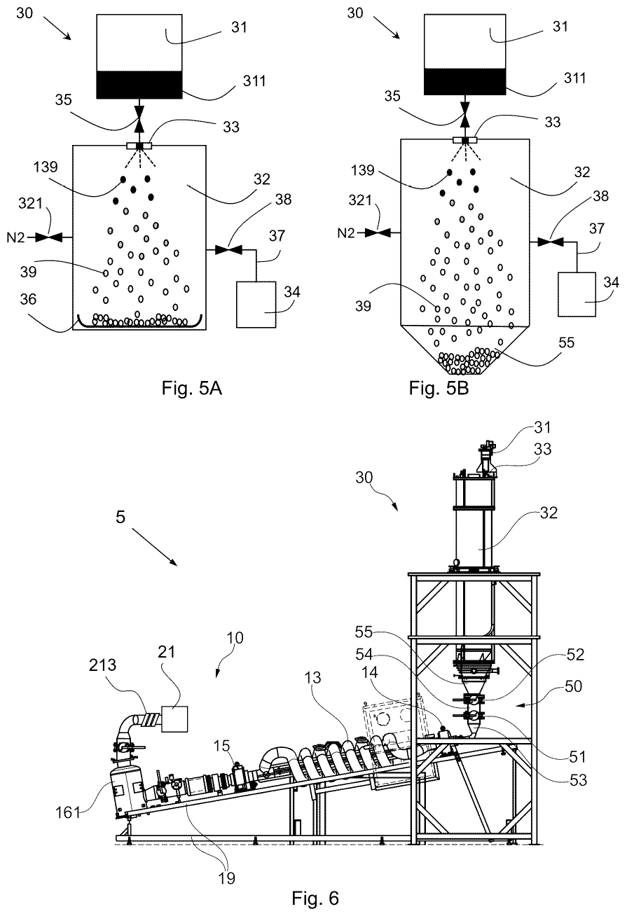

Hence, in examples of the present disclosure, the freeze-drying system may comprise a gentle freezing device. FIGS. 5A and 5B schematically illustrate a vacuum freezing device 30 according to two examples of the disclosure. The vacuum freezing device 30 may comprise a liquid container 31 configured for containing a liquid substance 311. The vacuum freezing device 30 may also comprise a vacuum chamber 32 in fluid communication with the liquid container 31 through at least one nozzle 33. The nozzle 33 may be configured for receiving the liquid substance 311 from the liquid container 31 and for spraying liquid droplets 139 into the vacuum chamber 32 in a controllable manner. The vacuum freezing device 30 may comprise an evacuation line 37 connected to a vacuum pump system 34. A valve 38 may be provided in the evacuation line 37 to control vacuum level in the vacuum chamber 32. In order to control a pressure inside the vacuum chamber 32, a micrometric valve 321 may be provided to introduce a controlled amount of an inert gas, e.g. nitrogen. In particular, a closed loop control may be envisaged, such that an amount of nitrogen may be introduced so as to keep a measured pressure in the vacuum chamber 32 within predetermined values.

In an example, a freeze-drying system comprising a single vacuum pump system to serve both the vacuum freezing device and the drying device may be envisaged. In other words, the vacuum pump system 21, shown in FIG. 1, and the vacuum pump system 34, shown in FIGS. 5A and 5B, may actually be combined in a single vacuum pump or vacuum pumping system.

The liquid substance 311 may comprise a solution with a solvent, e.g. water, and a solute dissolved in the solvent. Alternatively, the liquid substance may comprise a dispersion comprising a dispersoid in a dispersing medium. The solute or dispersoid may comprise a pharmaceutical or biological substance, e.g. medicines or chemicals constituting active pharmaceutical ingredients, to be processed.

In an example, the nozzle 33 may be provided at an upper position of the vacuum chamber 32 and the injected liquid substance may fall in the form of a spray. The design of the vacuum freezing device 30, e.g. the vertical dimensions of the vacuum chamber 32, and the operating conditions, e.g. liquid injection speed, viscosity of the solvent, temperature or pressure inside the vacuum chamber 32, may be selected such that the liquid droplets 139 are properly frozen before reaching a bottom section of the vacuum chamber 32.

According to these examples, liquid droplets 139 may be injected in a controlled manner and a fine spray may be obtained. Furthermore, the vacuum level in the vacuum chamber 32 may be such that the vacuum freezing of the liquid droplets 139 may be achieved as the liquid droplets 139 fall in the vacuum chamber 32. Accordingly, frozen particles 39 may be obtained from the liquid droplets 139 in a uniform and efficient manner. In particular, the pressure inside the vacuum chamber 32 may be such that an evaporation of the solvent in the outer surface of the liquid droplets 139 occurs. As a result of this evaporation, heat is removed from the liquid droplets 139, which leads to their subsequent freezing.

In an example, a valve 35 may be provided between the liquid container 31 and the nozzle 33. The flow of liquid may be controlled by adjusting pressure inside the liquid container 31, while the valve 35 may be simply controlled in an on-off manner such that liquid flow only takes place after appropriate vacuum conditions are present in the vacuum chamber 32. The rate of the liquid flow may be controlled by adjusting the pressure of the liquid container 31, such that an increased pressure may result in an increased injection of liquid into the vacuum chamber 32 per unit time. Furthermore, in other examples, the valve 35 may be adjusted to control a flow rate of liquid.

The vacuum freezing process is known to the skilled person so only the main principles of the mechanism will be summarized here. Thus, liquid droplets 139 may be sprayed from the nozzle 33. In some examples, depending on the design of the nozzle 33, the injected liquid may initially comprise a columnar liquid state. As the liquid flows in the vacuum chamber 32, this may be gradually dispersed, thus giving place to the formation of the liquid droplets 139.

Such substantially spherical liquid droplets 139 exhibit a large specific surface, i.e. a large surface to volume ratio, which results in short freezing and drying times. Water (or other solvent) vaporizes from the surface of the liquid droplets 139 due to the vacuum conditions in the vacuum chamber 32 and heat is removed from them due to the phase transition. Removal of heat results in a lowering of the temperature of the liquid droplets 139, which results in the start of a self-freezing process at the surface of the liquid droplets 139. This process progresses from the surface to the inner core of the liquid droplets 139, until the complete liquid droplet 139 is frozen and frozen particles 39 are obtained.

This process results in the formation of uniform frozen particles, i.e. particles of substantially uniform shape and size. Besides, a uniform concentration distribution is also achieved. Furthermore, no mechanical crushing or breaking processes are involved, so the structural integrity of the particles is maintained. As a further advantage of this process, the vacuum freezing process is an ultra-rapid, almost instantaneous, process. Accordingly, increased quality and reproducibility can be obtained. Besides, stability is also improved. In particular, control on the ice nucleation, control over the microscopic structure, and stability of the active pharmaceutical ingredients may be enhanced by such a rapid process. The fast freezing mechanism is such that cells, proteins or other active elements which may be present in the solution may not be deteriorated.

In an example, the sprayed liquid may comprise a solution wherein a pharmaceutical substance is dissolved in a solvent, such as water. Different concentrations may be used depending on the processed product, i.e. the solute, and the solvent used. A pressure in the range of 0.5 mbar or below, specifically below 0.1 mbar, may be maintained inside the vacuum chamber 32 and the nozzle 33 may be configured such that liquid droplets 139 of about 200 μm may be sprayed into the chamber 32.

The nozzle 33 may be configured to deliver the liquid substance 311 in a controlled manner. Accordingly, in an example of the disclosure, a size of the nozzle 33 may be adjustable so as to control a size of the liquid droplets 139. The size of the liquid droplets 139 may significantly affect the dynamics of the vacuum freezing process. Accordingly, the nozzle 33 may be adjusted to achieve the desired size. In some cases, different nozzles 33 may be provided but, in other cases, a nozzle 33 with adjustable dimensions may be selected to provide a more optimum tuning of the properties of the liquid droplets 139.

In an example, frozen particles 39 with dimensions in a range from 100 μm to 500 μm may be obtained while using a vacuum freezing device 30 as shown in any of FIG. 5A or 5B. Obviously, control on the size of the frozen particles 39 may also allow control on the size of the dried product, i.e. on the dried particles or granules. A small size of the frozen particles may allow a significant reduction of the drying time, thus shortening the cycle times for the freeze-drying process.

Apart from the size of the formed liquid droplets 139, the configuration of the nozzle 33 may also be adjusted to control the velocity of the liquid injected into the vacuum chamber 32. Such velocity may also influence the dynamics of the vacuum freezing process and, accordingly, the properties of the obtained frozen particles. This velocity may also be controlled or affected by adjusting the pressure in the liquid container 31.

In a variant, depicted in FIG. 5A, one or more trays 36 (or similar receptacles) may be arranged at a bottom part in an interior volume of the vacuum chamber 32. The trays 36 may be configured for collecting the frozen particles 39. Furthermore, the vacuum freezing device 30 may comprise a cooling system (not shown) configured for maintaining the trays 36 at a low temperature, specifically at a temperature down to −50° C.

The trays 36 may be used to effectively collect and maintain the frozen particles 39. In order to ensure properties of the frozen particles 39 are maintained, the temperature of the trays 36 may be kept sufficiently low, i.e. at a temperature not allowing a phase transition in the already frozen particles. Therefore, in an example, the trays 36 may be kept at a low temperature between −30° C. and −50° C. to prevent the frozen particles 39 from melting or deteriorating. Furthermore, the collection of the frozen particles in trays 36 may facilitate the subsequent handling of the particles, especially in cases comprising transfer of the particles to a drying device by means of an automatic system, e.g. a robot.

In another example, schematically depicted in FIG. 5B, the vacuum chamber 32 itself may comprise a bottom portion 55 with a tapered geometry. The tapered bottom potion 55 may facilitate accumulation and collection of frozen particles 39. This example may be especially adequate in freeze-drying systems comprising a direct connection between a vacuum freezing device 30 and a drying device 10.

When implementing a freeze-drying system comprising both a drying device and a freezing device, frozen particles need to be transferred from the freezing device to the drying device. To this end, in an example of the disclosure, a transition stage may be provided between the freezing device and the drying device. The transition stage may be configured for transporting the frozen particles from the freezing device to the drying device and it may be configured for maintaining the frozen particles at a low temperature during the transport.

The transition stage may comprise an automated conveying system comprising, e.g. a robot. Furthermore, the transition stage may comprise the use of a load lock system to load the frozen particles into the drying device. In particular, in an example comprising a vacuum freezing device 30 like the one depicted in FIG. 5A, the trays 36 containing the frozen particles may be conveyed and maintained at a low temperature in the transition stage and they may be transferred to a drying device 10 like the one depicted in FIG. 1 through an automated air lock system. Subsequently, the frozen particles in the trays 36 may be poured in the container 121 of the receiving station 12. In order to transfer the frozen particles into the receiving station 12, a load lock system may be provided.

In an example, the transition stage may comprise a valve system to communicate or isolate the vacuum freezing device 30 and the drying device 10. On the one hand, the valve system may be open to enable transportation of frozen particles from the vacuum freezing device 30 to the drying device 10. On the other hand, the valve system may be closed when material is not being transferred. In this manner, freezing of liquid droplets and drying of already frozen particles can be performed simultaneously, i.e. in parallel, in a continuous manner.

FIG. 6 provides a schematic overview of a freeze-drying system 5 comprising a vacuum freezing device 30 and a drying device 10. In this example, a vacuum freezing device 30 like the one depicted in FIG. 5B may be employed. The bottom portion 55 of the vacuum freezing device 30 may be connected to an intermediate chamber 54 through a first valve 52. Subsequently, the intermediate chamber 54 may be coupled to a container 53 through a second valve 51. The container 53 may substantially correspond to a container 121 of a receiving station 12 of the drying device 10 as schematically depicted in FIG. 1.

In this example, a continuous freeze-drying process may be provided. Thus, frozen particles 39 may be first accumulated in the bottom portion 55 of the vacuum chamber 32. After a certain quantity of frozen particles 39 are collected, the first valve 52 may be open to transfer such frozen particles 39 to the intermediate chamber 54. Subsequently, the first valve 52 may be closed again and the second valve 51 may be opened to transfer the frozen particles 39 to the container 53. After transfer of the frozen particles 39, the second valve 51 may also be closed. Subsequently, frozen particles 39 may be conveyed to the rotating tubular member 13 through the rotating joint 14 to initiate the drying process. Then, while some frozen particles 39 are being dried in the drying device 10, new frozen particles may be generated in the vacuum freezing device 30.

A pressure controlling system, e.g. a vacuum pump system, may be provided in the intermediate chamber 54. In this manner, the pressure in the intermediate chamber 54 may be equalized with either the vacuum chamber 32 of the vacuum freezing device 30 or the container 53 of the drying device 20. Accordingly, the pressure of the intermediate chamber 54 may be adjusted before opening the corresponding valves 52, 51. Alternatively, in another example, flow connections or bypasses, e.g. by means of ducts or pipes, with controllable valves may be provided between the intermediate chamber 54 and the inner volumes of the vacuum freezing device 30 and the drying device 10. Such controllable valves may be controlled to enable connection between the volumes, so that the respective pressures are equalized, before opening the valves 52, 51 enabling transfer of frozen particles. Other solutions may comprise the use of a load lock system.

Furthermore, in order to accommodate for different freezing and drying times, different configurations may be envisaged. Thus, in another example, a plurality of drying devices 10 like the one shown in FIG. 6 may be coupled to the same vacuum freezing device 30. A plurality of first valves 52, second valves 51, and intermediate chambers 54 may be arranged, each coupling the vacuum freezing device, i.e. its bottom portion 55, with a respective drying device 10. In this manner, a balance between the freezing process, which may be typically faster, and the drying process, may be achieved. As a result, the throughput of the freeze-drying system may be increased.

In other examples, alternative coupling mechanisms may be envisaged for the connection between the vacuum freezing device 30 and the drying device 10. In other words, different coupling mechanisms may be envisaged to enable transfer of frozen particles 39 from the vacuum freezing device 30 to the drying device 10. Hence, in another example, a rotating valve may be used. Such rotating valve may comprise one or more cavities for the collection of frozen particles 39. Upon rotation of the valve, frozen particles 39 may be automatically transferred to the drying device 10 in a continuous manner. Similarly to the previous example, a pressure accommodation system may be provided in the coupling mechanism to enable connection to either the vacuum freezing device or the drying device.

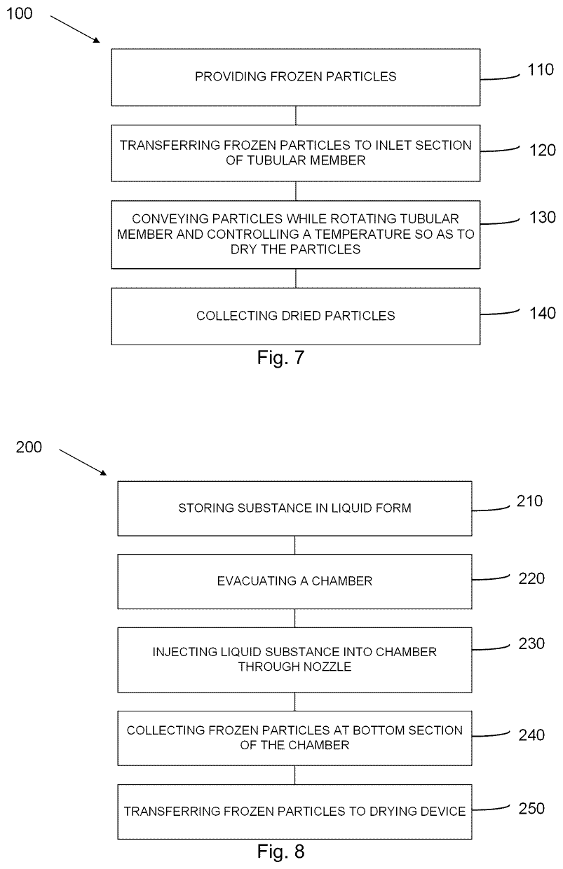

FIG. 7 shows a flowchart of an example of a method 100 for performing freezing-drying of a substance according to the disclosure. The method 100 comprises, in block 110, providing frozen particles of a substance in a drying device. The drying device comprises a rotatable tubular member at a vacuum. Block 120 of the method 100 comprises transferring the frozen particles to an inlet section of the tubular member, the tubular member comprising also an outlet section and an intermediate helical section. Then, in block 130, the frozen particles are conveyed along the tubular member from the inlet section to the outlet section while rotating the tubular member and controlling a desired temperature along the tubular member so as to continuously dry the particles while the particles are conveyed. In some examples, the pressure may also be controlled. Then, the dried particles are collected in a collection station in block 140.

The method 100 provides enhanced control of the drying sequence. In particular, method 100 provides enhanced control of the properties of the dried particles while favoring a gentle handling of the particles by conveying the particles along a helical tube, i.e. along an intermediate helical section of a tubular member, by rotating the tubular member. Furthermore, as already described with reference to the system depicted in FIG. 1, the method 100 may be particularly adequate for the processing of biological or pharmaceutical products observing cGMPs.

In an example, the rotatable tubular member 13 may be inclined with respect to a horizontal direction. Accordingly, translational movement of the particles may be facilitated during the drying process.

In an example of the method 100, controlling the temperature along the tubular member in block 130 may comprise individually controlling the temperature in at least three different temperature stages along a length of the tubular member.

According to this example, a more optimized, smooth and continuous drying process may be obtained as the frozen particles are conveyed along the tubular member and the temperature is gradually increased.

Moreover, the freeze-drying system may comprise a receiving station for receiving the frozen particles. Accordingly, a further temperature stage may be defined in the receiving station so as to prevent damage or melting of the frozen particles before transfer to the tubular member. The temperature of such temperature stage may also be controlled individually. Consequently, in some examples, temperature may be controlled individually in at least four different temperature stages; at least three individual states along a length of the tubular member and a further temperature stage in the receiving station.

Furthermore, in other examples of the method 100, rotating the tubular member in block 130 may comprise controlling and adjusting the rotational speed while the particles are conveyed, specifically in a range from 0.05 and 10 rpm.

According to this example, the rotational speed may be adjusted over a broad range even during a drying cycle. Therefore, the method 100 may be dynamically adjusted, such that improved properties of the dried substance may be ensured.

In still other variants of the method 100, the pressure at a position in an inner volume of the tubular member may be monitored and a vacuum level may be controlled such that it may be between 0.001 mbar and 2 mbar.

Similarly to the previous example, the improved control of the pressure during implementation of the method 100 may also provide a more dynamic adjustment of the process conditions, which may improve the properties of the dried substance.

Besides, other examples may provide a further improved control over the drying process. Thus, in such examples, a condition of the particles may be monitored while the particles are conveyed along the tubular member in block 130. A temperature, a rotational speed, and/or a pressure may be adjusted in response to the monitored condition. Specifically, the condition may comprise at least one of a temperature and a residual moisture of the particles at a predefined position of the tubular member.

According to this method, a closed-loop control of the freeze-drying process may be carried out. Thus, physical and/or chemical conditions of the particles may be monitored while the particles are conveyed along the tubular member. As a further example, the formation of particle clusters may also be monitored. To this end, a number of sensors may be distributed along the length of the tubular member. As an example, windows may be arranged on the surface of the tubular member, and non-contact temperature and/or humidity sensors may be provided. The readings of such sensors may be fed to a control system, e.g. to the control system 23 depicted in FIG. 1.

The control system 23 may then actively control different operational conditions of the drying device such as a rotational speed, a pressure, an inclination, a temperature distribution along the tubular member 13, or a temperature in the receiving station 12. Different control strategies may be implemented in the control system 23 to control the different variables. Thus, as non-limiting examples, on-off control, proportional control, or PID control methodologies, may be implemented for the control of the temperature at different positions of the tubular member 13 and for the control of the pressure during the process. Windows may also be used for visual inspection of the process. To this end, cameras may be provided. In examples comprising such closed-loop control, a diversion system may be provided in the drying device 10 to divert potentially non-conforming material. In particular, a specific valve may be arranged after the tubular member 13, i.e. after the outlet section 133 of the tubular member 13. Such a valve may be connected to a container configured for receiving non-conforming material.

FIG. 8 provides an example of a method 200 for providing the frozen particles of a substance. The method 200 comprises, in block 210, storing the substance in liquid form in a container. Block 220 of the method 200 comprises evacuating a chamber until a certain vacuum level is reached. Subsequently, in block 230, the liquid substance stored in the container is sprayed into the evacuated chamber through at least one spraying nozzle so as to generate frozen particles by vacuum freezing. The frozen particles are collected at a bottom section of the chamber in block 240. Finally, the method 200 comprises transferring the frozen particles to the drying device in block 250.

As already described in reference to the vacuum freezing device 30 depicted in FIGS. 5A and 5B, the method 200 may provide highly uniform frozen particles. In particular, the vacuum level reached at block 220 may be selected such that optimum vacuum freezing of the liquid droplets occurs. Such optimization may also take into account the design and/or operational condition of the nozzle.

In an example, block 220 may comprise evacuating the chamber until a vacuum level lower than a certain value of 0.5 mbar or lower, e.g. 0.1 mbar, is reached. Furthermore, block 230, comprising spraying of the liquid substance into the evacuated chamber, may not be carried out until collection trays 36 arranged at the bottom part of the vacuum chamber 32 or a bottom portion 55 of the vacuum chamber 32 do not reach a temperature lower than a certain value, e.g. −50° C. In this manner, it may be ensured that continuously produced frozen particles maintain their properties after deposition and collection.

The flowcharts depicted in FIGS. 7 and 8 may be combined when using a freeze-drying system 5 like the one depicted in FIG. 6.

This written description uses examples to disclose a teaching, including the preferred embodiments, and also to enable any person skilled in the art to put the teaching into practice, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, can be mixed and matched by one of ordinary skill in the art to construct additional embodiments and techniques in accordance with principles of this application. If reference signs related to drawings are placed in parentheses in a claim, they are solely for attempting to increase the intelligibility of the claim, and shall not be construed as limiting the scope of the claim.

1. A continuous freeze-drying system comprising:
a drying device configured for receiving frozen particles of a substance and for drying the particles, the drying device comprising a rotatable tubular member comprising an inlet section, an outlet section and an intermediate helical section;
a vacuum pump system for maintaining a vacuum inside the tubular member;
a temperature regulation system configured for controlling a desired temperature in the tubular member;
a drive for rotating the rotating tubular member and thereby conveying the particles, and
a control system for controlling the drive and the temperature regulation system such that the received frozen particles have been dried when arriving at and end of the outlet section.

2. The system of claim 1, wherein the inlet section of the tubular member is connected to a receiving station, the receiving station being configured for receiving the frozen particles, a connection between the inlet section of the tubular member and the receiving station comprising a rotating joint.

3. The system of claim 1, wherein the outlet section of the tubular member is connected to a separation station, the separation station being configured for separating dried particles from vapor, a connection between the outlet section of the tubular member and the separation station comprising a rotating joint.

4. The system of claim 1, wherein the tubular member is inclined with respect to a horizontal direction such that the inlet section is at a higher vertical position than the outlet section.

5. The system of claim 4, wherein the tubular member is tiltable and a tilting device is provided, the tilting device being configured for adjusting an inclination of the tubular member between 0° and 45° with respect to the horizontal direction.

6. The system of claim 1, wherein a plurality of temperature stages are defined along the tubular member, and the temperature regulation system is configured for individually controlling a temperature of the temperature stages.

7. The system of claim 6, wherein the plurality of temperature stages comprise at least three temperature stages, a first temperature stage including the inlet section, a second temperature stage including at least a portion of the intermediate helical section, and a third temperature stage including the outlet section, and further wherein the temperature regulation system is configured for adjusting the temperature such that the temperature is increased from the inlet section to the outlet section.

8. The system of claim 2, wherein a temperature stage is defined in the receiving station, the temperature regulation system being configured to individually control a temperature of the temperature stage defined in the receiving station.

9. The system of claim 1, wherein the tubular member has a radius in a range from 5 to 35 cm, the helical section extends for at least 50% of a length of a center axis of the tubular member and comprises at least two turns, and further wherein the helical radius is between 25 and 100 cm and the helical pitch is between 10 and 100 cm.

10. The system of claim 1, comprising a vacuum freezing device configured for receiving the substance in liquid state and for freezing the substance to generate the frozen particles of the substance, the vacuum freezing device comprising:
a liquid container configured for containing the liquid substance,
a vacuum chamber in fluid communication with the liquid container through a nozzle, wherein the nozzle is configured for receiving the liquid substance from the container and spraying liquid droplets into the vacuum chamber in a controllable manner.

11. The system of claim 10, wherein one or more trays are arranged at a bottom part in an interior volume of the vacuum chamber, the trays being configured for collecting the frozen particles, and further wherein the vacuum freezing device comprises a cooling system configured for maintaining the trays at a temperature between −30° C. and −50° C.

12. The system of claim 10, wherein a transition stage is provided between the vacuum freezing device and the drying device, the transition stage being configured for transporting the frozen particles from the vacuum freezing device to the drying device, the transition stage being configured for maintaining the frozen particles at a low temperature during the transport.

13. A freeze-drying method for performing freeze-drying of a substance, the method comprising:
providing frozen particles of a substance in a drying device, the drying device comprising a rotatable tubular member at a vacuum,
transferring the frozen particles to an inlet section of the tubular member, the tubular member comprising also an outlet section and an intermediate helical section,
conveying the frozen particles along the tubular member from the inlet section to the outlet section while rotating the tubular member and controlling a desired temperature along the tubular member so as to continuously dry the particles while the particles are conveyed, and
collecting the dried particles in a collection station.

14. The method of claim 13, wherein controlling the desired temperature along the tubular member comprises individually controlling the desired temperature in at least three different temperature stages along a length of the tubular member.

15. The method of claim 13, wherein providing frozen particles of a substance in a drying device comprises transferring the frozen particles to a receiving station of the drying device, the method further comprising individually controlling a temperature in the receiving station.

16. The method of claim 13, wherein a condition of the particles is monitored while the particles are conveyed along the tubular member, and further wherein a temperature, a rotational speed and/or a pressure are adjusted in response to the monitored condition.

17. The method of claim 16, wherein the condition comprises at least one of a temperature and a residual moisture of the particles at a predefined position of the tubular member.
